(19) United States
(12) Patent Application Publication
(10) Pub. No.: US 2011/0047480 A1
(43) Pub. Date: Feb. 24, 2011

(54) System and Method to aggregate users data that is spread all over the internet and show an uniform view in the form the user is most used to

(75) Inventor: Srinivasa Venkataraman, San Rafael, CA (US)

Correspondence Address: Srinivasa Venkataraman, 48 Skyview Terrace, San Rafael, CA, 94903, US

(73) Assignee: Primadesk Inc, San Rafael, CA (US)

(21) Appl. No.: 12/860,010

(22) Filed: Aug. 20, 2010

Related U.S. Application Data
(60) Provisional application No. 61/236,041, filed on Aug. 21, 2009.

(51) Int. Cl. G06F 15/16; G06F 3/048

(52) U.S. Cl. 715/748; 709/205

(57) ABSTRACT

This invention is a web based application that creates a private cloud for the user by bringing together portions of cloud based systems where the users assets (documents, emails, photographs etc.,) are stored. This system allows the users to move their files (and other assets) from one provider to another with ease as though all the assets are stored together. This invention removes the concept of cloud versus local assets by providing a seamless means to see and manage files irrespective of where they are stored. It also stores the relevant meta data on the assets so assets that are duplicated at different places can be easily identified and cataloged.

This invention also describes a method of searching through all the users data easily and effectively. Unlike searching the general internet content this search is specific to the user's personal content and the search will connect the related content.

### CROSS-REFERENCE TO RELATED APPLICATIONS

The application is based on the provisional application entitled “System and Method to aggregate users' data that is spread all over the internet and show an uniform view in the form the user is most used to,” filed on Aug. 21, 2009 provisional application No. 61236041 and EFS ID 5935611

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Cloud Computing Trends

This invention is in the field of helping individual users have instant access to their data that is spread all over the internet in different data centers of multiple vendors.

The users are in general used to having all their information in one place, their desktop or laptop. With the arrival of server based computing, cloud computing and other internet technologies their data is spread over several servers and data centers (As an example people have the photos of themselves, family and friends at different sites such as Flickr, Picasaweb, iphoto). To see their photographs and other documents they have to remember all the sites, related usernames, passwords etc.,.

Also they are not able to search across these assets and have an organized view (such as a directory structure in a desktop) of the assets (documents, email, photographs etc).

On the enterprise side a similar paradigm shift is happening.

Currently most companies are used to having all their data in their data centers. With advent of Salesforce.com and other hosted solutions the enterprise data and other assets are being distributed all over the internet in other data centers of the application vendors. Enterprise will need a consolidated view of all their assets to be able to use them and manage them better.

Need for Integrated View of the Data

So far PC users had all the information on their laptop or desktop so it was easier to access all their assets. With the advent of internet based applications and cloud computing that model has changed and the user data is spread out. As an example to access all the photos their care about (whether it is their own or that of family and friends) they may have to login to several different applications (flickr, Sanpfish, picasaweb etc.). This problem extends to every service users use on the internet such as online purchases, online travel planning, online document storage, online posts on different social networking sites and the list goes on. While the internet has made the collaboration much easier it has also introduced some constraints on the users. This invention tries to remove the constraints and make the internet use much easier for the users with respect to the access to all their assets. We do that by handling the complexities of interfacing with different sites and give the user a consolidated view of all their assets.

### BRIEF SUMMARY OF TUE INVENTION

The invention is an application that gives the users a streamlined view of all their data which is spread all over the internet on different applications such as Google docs, picasaweb, Flickr, facebook, myspace, box.net, Yahoo etc. When users access this application they will be able to see all their photographs (for example) in one place even though the actual files are distributed at different sites that manage photographs (Picasaweb, Flickr, Iphoto). They will be able to copy the content from one place to another as well as search all the content as though all the content is one place though in reality the content is distributed over several different service providers. Similarly they will be able to see a consolidated view of all their online purchases, online blogs and their other assets.

Similarly for a company this invention will give an aggregated view of all their assets that are being distributed in the data centers of application vendors such as salesforce.com, google and others. For example the information about customers and prospects may be distributed in different applications (salesforce.com and the like) and this application (invention) will give them a consolidated view of all their customers and prospects from different applications.

### BRIEF DESCRIPTION OF THE FIGURES

FIG. 1 describes how the user interacts with web based applications without this invention. All the different providers are an island and the user interacts with them individually. The users content from each one of these providers appear separately and the user cannot look at all his/her data in one place.

FIG. 2 figuratively represents how with this invention the entire cloud interaction appears seamless to the user.

FIG. 3 shows the consolidated view of all the users photos that are in different online service providers such as Picasa, Facebook, Smugmug etc. With this the user has instant access to all his/her photo irrespective of where it is physically present and they will be able to copy photos from one place to another simply by dragging and dropping the thumbnails.

FIG. 4

Represents the architecture for the invention.

Definitions: User—End user whose content is being consolidated. This could be an IT admin or a business owner in the corporate situation.

Server—Software (covered by this invention) running on a physical server on the internet.

Service—Online services such as Gmail, picasa, webshots, facebook etc., running on their own data centers on the internet.

A—represents the user making a request to look at all their content of a particular type (Say photos).

B—Represents the request from user being routed through the internet to the server.

C—Server sends out request to all the services that the user has configured to get the appropriate content from the service that belongs to this user. Server initiates multiple threads (one for each service) to get the information in parallel from all the services.

D & E—Server consolidates the information received from different services and sends to the user machine for displaying to the user.

### DETAILED DESCRIPTION OF THE INVENTION

At a high level the invention describes a system and method of providing a consolidated view of users data that is scattered across the internet in the form a desktop that users are familiar with. This also allows several operations (such as copy, delete, search etc.,) to be performed on the content as though it is all in one place.

1. A web based application that brings together all the users data from all over the internet to give them a unified view of their data irrespective of the location of the actual files

2. Ability to search through all the different sources seamlessly

3. Ability to automatically save all the online purchases and consolidate it under “My Purchases” menu

4. Ability to consolidate all different travel itineraries from different sources (Expedia, united, Travelocity, Orbitz etc.,)

5. Ability to store all web based applications to be organized and stored in one place so that people do not have to remember all the details of the applications (URL, username, password) even if they use these applications extremely rarely

6. Ability to see all your photographs from different photo management sites (Flickr, Picasaweb etc.,) in one place and the ability to move photos from one service to another by dragging and dropping the links to the photos.

7. Ability to see your files from different file sharing sites (google docs, box.net, Zoho etc.) in one place and the ability to move files from one service to another by dragging and dropping file links.

8. Ability to backup all the users data from different services on the internet to a single location on the users desktop or on a server in the cloud.

9. Ability to move resources (files, photos, postings etc.,) from one service (say picasaweb) to other services (say Flickr).

10. Ability to store the resources in a common format so that it can be used for any of the services. For example each photo management service may store different meta data about the pictures. We will come up with a comprehensive scheme that stores all different meta data and when we interact with a specific service (say flickr) we will pass the appropriate meta data.

11. Ability to report usage data for web based “hosted” applications within a corporation

12. Ability to store information related to users data so that relationship between resources can be identified. For example if the user copies a photograph from the local machine to an online service the file size may be reduced (since some online applications reduce the size of the photograph to reduce load on the server). This application will store the information on all the locations at which this photo is stored as well as the relative sizes at each location.

The invention is an entirely web based system to allow users have a consolidated view of all their assets on the internet as well as the local machine.

The user first logs into the server and configures all the web based applications that they use on a regular basis (such as gmail, facebook, orkut, Kodak gallery etc.,). Each account is also categorized (mail, photos, shopping etc.,). All the information is stored in a database on the server so they do not have to re-enter these the next time.

Next time the user logs into the system they have the option of going directly to the individual providers by clicking on the appropriate link for the provider or see a consolidated view of their content (such as photos, emails etc.,). All the user actions are recorded in a database so we can provider usage reports if necessary.

When they user clicks on a link to see all the photos a request is sent to the server. The server looks up the database and retrieves all the photo accounts this user has configured. The server then makes requests to all the appropriate services (such as picasa, flickr, Kodak gallery etc.) at once to retrieve user information from those services. Once the information is received it is passed on to the browser on user's machine for display locally. Any action user performs (such as deleting a photo, copying a photo to another album or another service etc.,) is sent back to the server for appropriate action. The server then sends the appropriate messages to the service (using API calls or by other means) to perform the action.

When the user is doing these tasks appropriate information about the task as well as about the content is stored in the database so user can be provided some additional information about the content which is not available currently.

The content on the local machine is also accessed by the system using the methods explained in section 6.5 so the users have a virtual view of all their content no matter whether it is local or on the internet somewhere.

The invention also provides a way for the users to search across all their content no matter where the content is actually stored. When the user issues the search command the system sends a search query to all the different web based services the user has configured. As the information is received from these different services it is consolidated and sent to the end users machine for display. Any failures by the services are gracefully handled by the system. Enough information is sent to the users machine so if the user clicks on the search results they are taken directly to the appropriate service to see more details. For example if the user searches for a keyword called Maui and if the search result has a photograph, from facebook album, tagged with the keyword then when the user clicks on the photograph in the search result they are taken directly to Facebook, logged in and taken to the photograph. Now they are ready to work with the photograph as they see fit.

As the user uses the system meta data is collected on the usage, history and on the content (type, size and other parameters) so that the users can be given a consolidated view of their data across all their services. For example as the user copies a photo to different services (such as facebook, picasa etc.,) from their local machine the system maintains the history of all these actions so that the user can get a report of all the locations this photo exists, size of the photo on different services etc., etc.

Enough information will also be collected on the content so that they can be tagged together as an event. For example by knowing the dates of an even like a vacation all the user data between those dates (photos taken, shopping done etc.,) can be grouped and tagged as being related to that vacation.

The invention also mentions a way for users to look at all the files on the local machine along with all the files on different online services and download the files from online systems to local machine using drag and drop. The locals files are enumerated using the plugins (or add-ons based on the browser) along with all the online content and the user will be able to manage this files as though all the files are in one place. This is explained in section 6.5 in detail.

6. How Does It Work:

a. The users will create an account in our web based system.

b. Once they log in they will be able to configure their account by giving the details of all the web based applications that they use (google, yahoo, flickr, expedia, ebay, Travelocity, Bank of America, citi cards, etc., etc.,). They will also be able to categorize their applications (Financial, travel, etc.,)

c. Once we have their account information we will be able to seamlessly aggregate all the relevant data and show them a consolidated view. For example we will be able to consolidate all the photo sharing sites and show all the users photo from different locations (flickr, snapfish etc,) nicely in one place. We will also integrate this with the My Pictures menu from the Windows desktop so that the users can view photos from their local machine and from online sites in one place. They will also be able to download some of these files automatically based on some rules and save it on their local desktop.

d. Similar facility will be provided for all other types of data (files, financial data etc., etc.)

Main functionality:

1. Ability for the users to seamlessly login to their online accounts by simply clicking a link avoiding the need for users to remember URL, username and password and having to type them in each time.

2. Ability to look at all the related assets in one place (example: Consolidated view of all their photos in one place no matter which online service the photos are actually stored) see FIG. 3.

3. Ability to collect usage data on all the web based applications that the users are using and report on the usage (only for enterprise application).

4. Ability to track related information about an asset and report on it. For example tracking the fact a photograph was copied to several different services (picasa, facebook etc,) and reporting on the actual dates they were copied and what are the current resolution and size of the photos on different services etc. Similar connections also can be made to an event such as a vacation. Photos, shopping and travel may be connected to a specific vacation or other events.

The system is a completely web based implementation with a small client (browser plugin) implemented to achieve integration with the local machine.

The server side implementation is explained in FIG. 5.

1. User requests for a Service (Photo Service) invoking corresponding action on the server.

2. A local call is made from Action class to Service Manager to retrieve service Providers.

3. Service Providers information which is persisted on server is retrieved using JPA.

4. With service Providers information in user session, request is forwarded to JSP

5. Appropriate User response is rendered to User with Providers information and their capability. (Example: Display List of Photo Providers)

6. An Ajax call is made to server based on functionality a user is interested in with one or more Providers (get Albums, Copy one photo from one Provider to another etc. . . . )

7. A local call is made to Service Manager to invoke one or more Service Providers.

8. Provider Implementations invoke Third Party API provided by different Providers to complete the service.

9. A response is sent asynchronously to user based on how the request completion status.

Implementation of the client side (plugin): Section 6.5 describes the client side implementation in detail.

6.5. Communication Between the Browser and Local Data Files Using the Extensions, Add-Ons, Plugins, and Helper Objects

6.5.1 Implementation Overview

To facilitate operations that access the local file system and to facilitate the Single Sign On process, the invention implements some functionality as browser add-ons. Browser add-ons are programs and instructions which alter or extend the functionality of a web browser program, and are well known in the art.

The browser add-on is implemented using the models described by the Mozilla Foundation for implementing Firefox Extensions and Plugins, by Microsoft for implementing a Internet Explorer-based ActiveX Controls and Browser Helper Objects, and by Google and the Mozilla Foundation for implementing Chrome Extensions and Plugins.

Methods of implementing Firefox Extensions and Plugins are well known in the art; documentation is available at https://developer.mozilla.org/en/extensions and https://developer.mozilla.org/en/Plugins.

Methods of implementing Internet Explorer ActiveX Controls and Browser Helper Objects are well known in the art; documentation is available at http://msdn.microsoft.com/en-us/library/aa751972.aspx and http://msdn.microsoft.com/en-us/library/Bb250436.aspx.

Methods of implementing Chrome Extensions and Plugins are well known in the art; documentation is available at http://code.google.com/chrome/extensions/devguide.html. Additional documentation on the development model is available at https://developer.mozilla.org/en/extensions and https://developer.mozilla.org/en/Plugins.

6.5.2 Installation Package

Firefox Browser

An installation package is provided for the Firefox browser. This package includes:

An extension, and registration information for registering the extension with the browser, which detects Single-Signon interactions and enables automatically signing the user into the destination web site.

A plugin, which enables access to files on the local file system, accesses or produces thumbnail image representations for display, allows copying files from the local system to a remote system (uploading), allows copying files from a remote system to the local system (downloading), and allows copying files between directories in the local system (local copy).

The installation package is created using standard tools for creating a Firefox Extension package. Preferably, the package is cryptographically signed using standard Firefox Extension signing tools.

Internet Explorer Browser

An installation package is provided for the Internet Explorer browser. This package includes a single Windows DLL, which contains code to implement:

A Browser Helper Object, which detects Single-Signon interactions and enables automatically signing the user into the destination web site.

An ActiveX control, which enables access to files on the local file system, accesses or produces thumbnail image representations for display, allows copying files from the local system to a remote system (uploading), allows copying files from a remote system to the local system (downloading), and allows copying files between directories in the local system (local copy).

Preferably, the Windows DLL is cryptographically signed using standard Microsoft Authenticode Codesigning tools.

Chrome Browser

An installation package is provided for the Chrome browser. This package includes:

An extension, and registration information for registering the extension with the browser, which detects Single-Signon interactions and enables automatically signing the user into the destination web site.

A plugin, which enables access to files on the local file system, accesses or produces thumbnail image representations for display, allows copying files from the local system to a remote system (uploading), allows copying files from a remote system to the local system (downloading), and allows copying files between directories in the local system (local copy).

The installation package is created using standard tools for creating Chrome Extension packages. Preferably, the installation package is cryptographically signed using these tools.

Package Installation

As part of the activation process for the service, the end-user downloads and installs the installation package that is appropriate for their browser.

Once the package is installed, the service can then enable features of the add-on package, including: single-signon, access to the local file system, producing thumbnail image representations of local files, uploading files, downloading files, and copying files locally.

6.5.3 Detailed Description of the Firefox Plugin

The Firefox plugin is implemented as a Windows DLL which is implemented according to the model of a scriptable Firefox plugin. This model allows the service to cause the plugin object to be instantiated within a web page. The plugin defines an object which can be invoked from JavaScript from the web page on which it is instantiated, and methods which can be called from JavaScript on the web page. These methods include the ability to list files and directories in a local storage device, list files within a directory on the local storage device, upload local files to a remote server, download to local files from a remote server, and copying files locally.

The Firefox Extension is implemented as a set of JavaScript files according to the model of a Firefox Extension. In this model, the extension is invoked for each web page loaded by the browser, and the extension inspects the page to see if it will be part of the Single Sign On process. The extension can then communicate with the server in order to exchange information required to complete the Single Sign On process.

6.5.4 Detailed Description of the Internet Explorer Add-On

The ActiveX Control is implemented as a Windows DLL which is implemented according to the model of a scriptable Internet Explorer plugin. This model allows the service to cause the plugin object to be instantiated within a web page. The plugin defines an object which can be invoked from JavaScript from the web page on which it is instantiated, and methods which can be called from JavaScript on the web page. These methods include the ability to list files and directories in a local storage device, list files within a directory on the local storage device, upload local files to a remote server, download to local files from a remote server, and copying files locally.

The Windows DLL also includes an implementation of the Login Helper Object, according to the model of a Browser Helper Object add-on. In this model, the Browser Helper Object (BHO) is invoked for each web page loaded by the browser, and the BHO inspects the page to see if it will be part of the Single Sign On process. The BHO can then communicate with the server in order to exchange information required to complete the Single Sign On process.

6.5.5 Detailed Description of the Chrome Plugin

The Chrome plugin is implemented as a Windows DLL which is implemented according to the model of a scriptable Chrome plugin. This model allows the service to cause the plugin object to be instantiated within a web page. The plugin defines an object which can be invoked from JavaScript from the web page on which it is instantiated, and methods which can be called from JavaScript on the web page. These methods include the ability to list files and directories in a local storage device, list files within a directory on the local storage device, upload local files to a remote server, download to local files from a remote server, and copying files locally.

The Chrome Extension is implemented as a set of JavaScript files according to the model of a Chrome Extension. In this model, the extension is invoked for each web page loaded by the browser, and the extension inspects the page to see if it will be part of the Single Sign On process. The extension can then communicate with the server in order to exchange information required to complete the Single Sign On process.

Those skilled in the art will appreciate that the Chrome plugin model is very similar to the Firefox plugin model; therefore, code is preferably shared between the Chrome plugin and the Firefox plugin.

Those skilled in the art will appreciate that a Windows DLL can contain multiple separate and distinct libraries of code, and that preferably, the Firefox, Internet Explorer and Chrome Plugins are packaged together in one DLL.

Detailed Description of the Single Sign On Process

Code That Goes Into the Plugin to Implement the Process:

When a page is loaded, the browser invokes the Single Signon Helper (SSOH) to inform it that a new page has been loaded, and to allow the SSOH to perform actions to complete the SSO process.

The SSOH inspects the page URL. If the page URL is a Start SSO Process page, the SSOH retrieves a redirection URL stored in the page, preferably as a value stored in a field in a form tag.

The redirection address is the address of the web site to which the browser SSOH redirects the browser, to perform the login. In most cases, this is the page that contains a login form for the site. In other cases, the page pointed to by the redirection address starts a chain of redirections which end in a page containing a login form for the site. In any case, it is expected that the browser will eventually settle on a page which contains a login form for the site.

The SSOH requests a login method, including login credentials, from the SSO server. The SSO server returns a sequence of JavaScript code, which is designed to be injected into the login page, and which, when executed, will have the effect of filling in the login form with the user's credentials and posting the form to the site.

Posting the login form to the site will have the effect of logging the user into the site. In some circumstances, the site will interpret the redirection URL to indicate that it should send the user to a specific part of the site, such as an application for viewing or editing content specified in the redirection URL. Such a case would be useful to send the user to a specific web page for viewing or editing specific content, such as a specific image.

6.5.6 Detailed Description of File Access Methods

GetLocalFiles

The GetLocalFiles method provides a means to retrieve a list of filenames on a local storage device. The method receives a directory path name as an input parameter, and returns the list of files as an output parameter. The method, as implemented in the plugin, uses operating system library functions to retrieve a list of names of files and/or directories which are contained in the specified directory path.

The method can also receive as input a special path name to indicate that the requested root path is the “My Computer” pseudo-folder. In this case, the method returns a list of local storage devices and other directories that may be of interest to the user, which may include the “My Pictures” and “My Documents” directories, and other system-defined special directories and pseudo-folders.

CopyFiles

The Copy Files method provides a means of uploading files, downloading files and copying files on the local computer. Methods for copying a file between locations on a computer's local storage medium, or from a computer's local storage to a location on a network, or from a location on a network to the local computer, are well known in the art.

When the CopyFiles method is used as part of the process of uploading a file from the local machine to a remote service, the plugin uses an HTTP POST to the REST API function of the server for uploading. In performing the HTTP POST, the plugin submits a form containing a specification of the destination location in field called path; this value describes the intended final destination of the file. The value of the destination path parameter was provided as a parameter to the CopyFiles method; in turn, this value was provided by the server when the client application retrieved the list of service providers that could be used as a destination. The plugin also submits the actual file content to the server as another part in the multipart HTTP POST message.

### REFERENCES

U.S. Pat. No. 6,233,600 Salas et al., May 2001 Method and system for providing a networked collaborative work environment

U.S. Pat. No. 7,386,569 Berstis et al., June 2008 Systems, methods, and media for aggregating electronic document usage information

U.S. Pat. No. 7,441,049 Chasman et al., October 2008 Simplified application object data synchronization for optimized data storage

U.S. Pat. No. 7,448,032 Bourbonnais; Roch November 2008 Method and apparatus for integration of URL into standard file systems

U.S. Pat. No. 7,490,045 Flores, et al. February 2009 Automatic collection and updating of application usage

U.S. Pat. No. 7,552,170 Owen, et al. June 2009 Apparatus and method for aggregating web services

U.S. Pat. No. 7,574,671 Keohane, et al. August 2009 Apparatus and method of displaying electronic desktops based on a scheduler or network connection

U.S. Pat. No. 7,574,691 Freitas, et al. August 2009 Methods and apparatus for rendering user interfaces and display information on remote client devices

What is claimed:

1. A method and system for aggregating all the users data from various sources on the internet and showing it to the users in a seamless fashion on any device and give them the ability copy content from one service to another.

2. The method and system of claim 1, where one of the sources can be the local computer.

3. The method and system of claim 1 where the user can be a company

4. The method and system of claim 1, further comprising ability aggregate information (not just data) related to the users and show it to the user (example of information from United Airlines as well as Expedia about a trip).

5. The system of claim 1, further comprising the ability to search through all the sources seamlessly

6. The system and method of aggregating all the users data from various sources on the internet and the ability back up the said data to the location specified by the user

7. The system of claim 6, wherein the location may be user's computer

8. The system of claim 6, wherein the location may be a server on the internet

9. They system for tracking the usage of various web based applications and reporting to a server on user by user basis.

10. A system to store related information about an users asset on the internet. This will include storing location, size, quality and other details about the said asset as well as the relationship to other assets belonging to the user.

11. System and method to download files onto a local system purely within the context of the browser using drag and drop.
